(19) United States
(12) Patent Application Publication
(10) Pub. No.: US 2020/0024095 A1
(43) Pub. Date: Jan. 23, 2020

(54) APPARATUS AND METHOD FOR FORMING IMAGE

(71) Applicant: CANON KABUSHIKI KAISHA, Tokyo (JP)

(72) Inventor: Hiroharu Tsuji, Numazu-shi (JP)

(21) Appl. No.: 16/586,691

(22) Filed: Sep. 27, 2019

Related U.S. Application Data
(63) Continuation of application No. PCT/JP2018/024160, filed on Jun. 26, 2018.

(30) Foreign Application Priority Data
Jul. 3, 2017 (JP) 2017-130523

(51) Int. Cl. B65H 29/60; B65H 31/10; G03G 15/00

(52) U.S. Cl. CPC B65H 29/60; G03G 15/6541; B65H 31/10

(57) ABSTRACT

An image forming apparatus includes an image forming unit and a conveying unit connected to the image forming unit. The image forming unit forms an image on a sheet. The conveying unit conveys the sheet, discharged from the image forming unit, in which an image is formed on a first side by the image forming unit toward the image forming unit, with the first side and a second side opposite to the first side reversed. The conveying unit includes a first processing unit that performs processing on the sheet having the image formed on the first side by the image forming unit and conveyed toward the image forming unit.

### CROSS-REFERENCE TO RELATED APPLICATIONS

This application is a Continuation of International Patent Application No. PCT/JP2018/024160, filed Jun. 26, 2018, which claims the benefit of Japanese Patent Application No. 2017-130523, filed Jul. 3, 2017, both of which are hereby incorporated by reference herein in their entirety,

### TECHNICAL FIELD

The present invention relates to an apparatus and a method for forming an image on a sheet.

### BACKGROUND ART

Some image forming apparatuses, such as printers, copying machines, and multi-functional printers, have the function of punching, joining, and bookbinding. PTL 1 discloses a post-processing unit including punching unit, stapling unit, and a folding unit to perform necessary processing on sheets received from the main body of the copying machine.

In performing image formation on both sides of a sheet and processing on the sheet, the processing on the sheet is started after completion of the image formation on both sides of the sheet in the related art. In this case, the step of reversing the conveying direction of the sheet on which an image is formed on a first side to convey the sheet toward an image forming unit and the step of processing the sheet on which images are formed on the first side and the second side are separately executed, thus leaving room for improving the production efficiency of the image forming apparatus.

### CITATION LIST

### Patent Literature

PTL 1 Japanese Patent Laid-Open No. 2013-177234

### SUMMARY OF INVENTION

The present invention provides an apparatus and a method for productive image formation.

An image forming apparatus in an aspect of the present disclosure includes image forming unit configured to form an image on a sheet and conveying unit connected to the image forming unit and configured to convey the sheet discharged from the image forming unit. The conveying unit is configured to convey the sheet in which an image is formed on a first side by the image forming unit toward the image forming unit, with the first side and a second side opposite to the first side reversed. The conveying unit includes a first processing unit configured to performing processing on the sheet having the image formed on the first side by the image forming unit and conveyed toward the image forming unit by the conveying unit.

Further features of the present invention will become apparent from the following description of exemplary embodiments with reference to the attached drawings.

### BRIEF DESCRIPTION OF DRAWINGS

FIG. 1 is a schematic diagram of an image forming apparatus according to a first embodiment of the present disclosure.

FIG. 2 is a perspective view of the image forming apparatus according to the first embodiment.

FIG. 3 is a perspective view of a punching processing unit according to the first embodiment.

FIG. 4 is a perspective view of the relevant part of the punching processing unit according to the first embodiment.

FIGS. 5A to 5C are schematic diagrams illustrating the individual steps of a punching operation performed by the punching processing unit according to the first embodiment.

FIGS. 6A to 6C are schematic diagrams illustrating the individual steps of a sheet conveying operation performed by the image forming apparatus according to the first embodiment.

FIG. 7 is a block diagram illustrating the control configuration of the image forming apparatus according to the first embodiment.

FIG. 8 is a flowchart illustrating the control process of the image forming apparatus according to the first embodiment.

FIG. 9 is a schematic diagram of an image forming apparatus according to a second embodiment of the present disclosure.

FIG. 10 is a schematic diagram of an image forming apparatus according to a third embodiment of the present disclosure.

FIG. 11 is a schematic diagram of an image forming apparatus according to a fourth embodiment of the present disclosure.

### DESCRIPTION OF EMBODIMENTS

Image forming apparatuses according to embodiments of the present disclosure will be described hereinbelow with reference to the drawings. Examples of the image forming apparatuses include printers, copying machines, facsimile machines, and multi-functional machines, which form images on a sheet used as a printing medium based on image information input from an external personal computer (PC) or image information read from an original. Example of the sheet used as a printing medium include paper, paper for envelopes, a plastic film, such as an overhead projector transparent (OHT) sheet, and cloth.

### First Embodiment

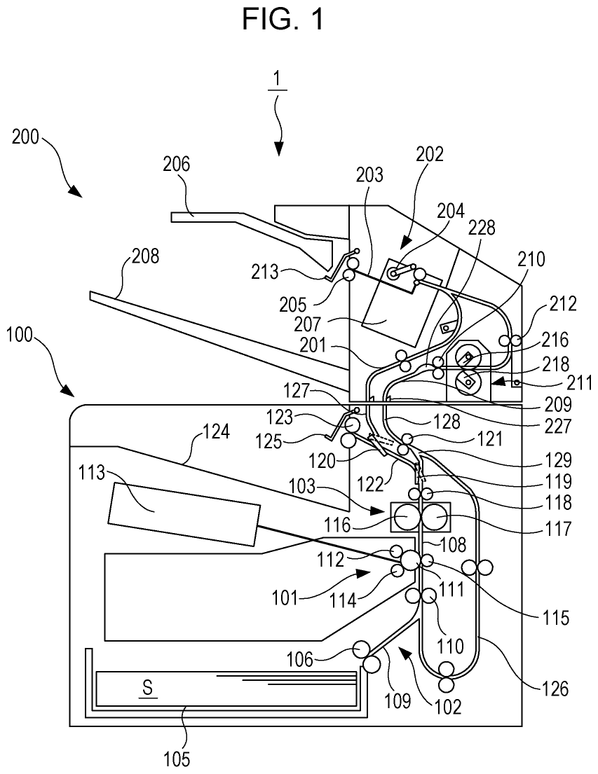

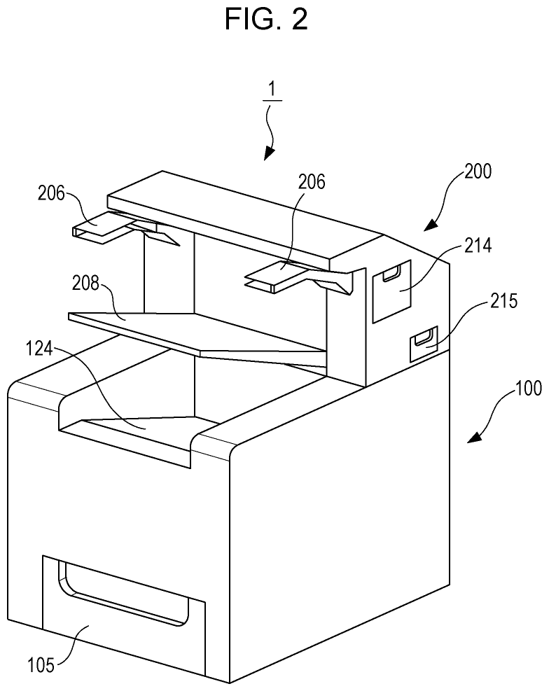

An image forming apparatus according to a first embodiment will be described with reference to FIGS. 1 to 8. As illustrated in FIGS. 1 and 2, an image forming apparatus 1 according to the present embodiment is a monochrome digital printer including an apparatus main body 100, which is a first casing, including an image forming unit 101 and a post-processing unit 200 joined to the top of the apparatus main body 100 and serving as a conveying unit. The post-processing unit 200 is a second casing detachably mounted to the apparatus main body 100 and serves as a conveying unit for conveying sheets discharged from the apparatus main body 100 and conveying the sheets back to the apparatus main body 100 again.

FIG. 1 is a schematic diagram illustrating the cross-sectional configuration of the image forming apparatus 1. FIG. 2 is a perspective view of the image forming apparatus 1 illustrating the whole.

As illustrated in FIG. 1, the apparatus main body 100 includes the electrophotographic image forming unit 101, a sheet feeding unit 102 that feeds sheets to the image forming unit 101, and a fixing unit 103 that fixes images on the sheets. The image forming unit 101 incudes a photosensitive drum 111, which rotates clockwise in FIG. 1 an exposure unit 113, a charging roller 112, a developing unit 114, and a transfer roller 115 disposed along the direction of rotation of the photosensitive drum 111. The image forming unit 101 forms a toner image on the surface of the photosensitive drum 111, which is a photo conductor, by an electrophotographic process and transfers the toner image to the sheet S with the transfer roller 115.

The sheet feeding unit 102 includes a sheet cassette 105 in which a plurality of sheets S for image formation are stacked, a feed roller pair 106, a feed path 109 serving as a sheet feeding means, and a registration roller pair 110. The sheet feeding unit 102 feeds the sheets S contained in the sheet cassette 105 one by one with the feed roller pair 106 and corrects the skew of the sheets S with the registration roller pair 110. Thereafter, the registration roller pair 110 sends the sheet S toward the transfer roller 115 at a timing synchronized with the progress of toner image formation performed by the image forming unit 101.

The fixing unit 103 includes a fixing roller 116, a pressure roller 117 that is in pressure-contact with the fixing roller 116, and a conveying roller pair 118 that conveys the sheet S that has passed through the nip between the fixing roller 116 and the pressure roller 117. The fixing unit 103 fixes the toner image onto the sheet S by applying heat and pressure to the toner image while holding and conveying the sheet S. The sheet S sent out of the conveying roller pair 118 is conveyed toward either a first discharge roller pair 123 or the post-processing unit 200.

The post-processing unit 200, which is an example of a sheet processing unit, includes a punching processing unit 211, which is a first processing unit, a binding processing unit 202, which is a second processing unit, a second discharge roller pair 205, which is a second discharge unit, and a second stacking unit 208. The post-processing unit 200 is capable of forming a hole in the sheets S received from the apparatus main body 100 one by one with the punching processing unit 211, as will be described in detail below. The post-processing unit 200 is capable of executing binding of a plurality of sheets S received from the apparatus main body 100 with the binding processing unit 202.

### Sheet Conveying Path

Next, a conveying path for the sheets S provided in the apparatus main body 100 and the post-processing unit 200 will be described.

The apparatus main body 100 roughly includes the feed path 109, an image forming path 108, a discharge path 122, a first reversing path 128, a reconveying path 126, and a first binding path 127. The feed path 109 is a sheet conveying path extending from the feed roller pair 106 to the registration roller pair 110. The image forming path 108 is a sheet conveying path extending from the registration roller pair 110 to the conveying roller pair 118 of the fixing unit 103.

The discharge path 122 is a sheet conveying path extending from the conveying roller pair 118 to the first discharge roller pair 123. The first discharge roller pair 123, which is a first discharge unit, is capable of discharging the sheets S from the apparatus main body 100 onto a first stacking unit 124 provided at the upper part of the apparatus main body 100. A full-load detection lever 125 capable of detecting the amount of sheets S stacked on the first stacking unit 124 is disposed in the vicinity of the first discharge roller pair 123.

The first reversing path 128 is a sheet conveying path branching off the discharge path 122 and connected to a second reversing path 209 provided in the post-processing unit 200. A first switching member 119 is disposed at the branch point between the discharge path 122 and the first reversing path 128. The first switching member 119 can switch between an orientation for guiding the sheet S along the discharge path 122 toward the first discharge roller pair 123 and an orientation for guiding the sheet S to the first reversing path 128. The first reversing path 128 is provided with a reversing roller pair 121 capable of forward and reverse rotation, which serves as a reverse conveying unit configured to reversely convey the sheet S.

The reconveying path 126 is a sheet conveying path connecting the first reversing path 128 and the feed path 109 to convey the sheet S reversed by the reversing roller pair 121 toward the registration roller pair 110. The reversing roller pair 121 is disposed downstream from a branch point 129 between the first reversing path 128 and the reconveying path 126 in the direction of the sheet S conveyed by the conveying roller pair 118.

The first binding path 127 is a sheet conveying path branching off the discharge path 122 and connected to a second binding path 201 provided in the post-processing unit. A second switching member 120 is disposed at a branch point between the discharge path 122 and the first binding path 127. The second switching member 120 can switch between an orientation (a first orientation) for guiding the sheet S along the discharge path 122 toward the first discharge roller pair 123 and an orientation (a second orientation) for guiding the sheet S to the first binding path 127.

The post-processing unit 200 includes the second reversing path 209 and the second binding path 201. The second reversing path 209 constitutes a reverse conveying path through which the sheet S is reversely conveyed together with the first reversing path 128 in the apparatus main body 100. The second binding path 201 constitutes a conveying path through which the sheet S is conveyed toward the binding processing unit 202 together with the first binding path 127 in the apparatus main body 100.

The second reversing path 209 is provided with a punching unit 224 (described later) constituting the punching processing unit 211, a registration roller pair 210, and a conveying roller pair 212. Both of the registration roller pair 210 and the conveying roller pair 212 corresponding to a reverse conveying unit are rollers capable of forward and reverse rotation. A conveyance sensor 227 capable of detecting the sheet S is disposed at an opening of the second reversing path 209 facing the first reversing path 128. An end of the second reversing path 209 far from the first reversing path 128 joins with the second binding path 201.

Of the above sheet conveying paths, the discharge path 122 in the apparatus main body 100 corresponds to a first conveying path for conveying the sheet S on which an image is formed by the image forming unit 101 to the first discharge roller pair 123 which is the first discharge unit. The first reversing path 128 corresponds to a second conveying path branching off the first conveying path, and the second reversing path 209 in the post-processing unit 200 corresponds to a third conveying path connected to the second conveying path. The first binding path 127 in the apparatus main body 100 corresponds to a fourth conveying path branching off the first conveying path. The second binding path 201 in the post-processing unit 200 corresponds to a fifth conveying path connected to the fourth conveying path.

The binding processing unit 202 is disposed downstream from the second binding path 201. The binding processing unit 202 includes an intermediate stacking unit 203, a binding unit 207, a conveying-direction aligning unit 204, a widthwise aligning unit 206, and the second discharge roller pair 205. The second stacking unit 208 is disposed downstream from the binding processing unit 202. The second discharge roller pair 205, which is the second discharge unit, is capable of discharging the sheet S conveyed through the first binding path 127 and the second binding path 201 to the binding processing unit 202 and bound as necessary to the second stacking unit 208. A full-load detection lever 213 capable of detecting the amount of sheets S stacked on the second stacking unit 208 is provided in the vicinity of the second discharge roller pair 205.

As illustrated in FIG. 2, a staple refilling unit 214 and a punched-scrap collecting unit 215 are provided on a side of the post-processing unit 200. The staple refilling unit 214 is a door for accessing a staple cartridge to refill staples when staples in the binding unit 207 (see FIG. 1) are run out. The punched-scrap collecting unit 215 is an access unit for drawing a punched-scrap box from which the punched scraps of the sheets S generated by punching are collected and discarding the punched scraps.

### Operations of Components

The operations of the components of the apparatus main body 100 and the post-processing unit 200 will be described hereinbelow. First, the operation of discharging the sheet S to the first stacking unit 124 in the apparatus main body 100 will be described. The sheet S to which an image is fixed by the fixing unit 103 is conveyed downstream by the conveying roller pair 118. When the first switching member 119 and the second switching member 120 are at the broken line positions in FIG. 1, the sheet S is guided along the discharge path 122 to the first discharge roller pair 123 and is discharged to the first stacking unit 124 by the first discharge roller pair 123. When more than a predetermined amount of sheets S are stacked on the first stacking unit 124, it is detected by the full-load detection lever 125 that the first stacking unit 124 is fully stacked with the sheets S. In this case, a control unit 150 (described later) performs control so that no sheet S is conveyed to the first stacking unit 124 until the sheets S are removed from the first stacking unit 124.

Next, the operation of discharging the sheet S to the second stacking unit 208 will be described. When the first switching member 119 is at the broken line position in FIG. 1, and the second switching member 120 is at the solid line position in FIG. 1, the sheet S sent out of the conveying roller pair 118 is guided to the binding processing unit 202 through the first binding path 127 and the second binding path 201.

The second discharge roller pair 205 is a contactable and separable roller pair, which is held at the contact position when the sheet S is not to be bound. In this case, the sheet S conveyed to the binding processing unit 202 continues to be conveyed by the second discharge roller pair 205 and is discharged and stacked onto the second stacking unit 208. When more than a predetermined amount of sheets S are stacked on the second stacking unit 208, it is detected by the full-load detection lever 213 that the second stacking unit 208 is fully stacked with the sheets S. At that time, the control unit 150 performs control so that no sheet S is conveyed to the second stacking unit 208 until the sheets S are removed from the second stacking unit 208.

In binding the sheet S with the binding processing unit 202, the second discharge roller pair 205 is at the separate position, and a plurality of sheets S are stacked on the intermediate stacking unit 203. The sheets S stacked on the intermediate stacking unit 203 are aligned in widthwise position by the widthwise aligning unit 206, which is a pair of alignment members, and are aligned in conveying direction by the conveying-direction aligning unit 204 that is in contact with the upper surface of the sheets S. Such alignment processing is performed every time one sheet S is discharged to the intermediate stacking unit 203. Upon completion of alignment of a predetermined number of sheets S, the batch of sheets is bound by the binding unit 207. Upon completion of the binding processing, the separated second discharge roller pair 205 moves to the contact position and rotates, so that the batch of sheets is discharged from the intermediate stacking unit 203 onto the second stacking unit 208.

Next, the operation of printing both sides of the sheet S will be described. However, punching processing performed halfway through two-sided printing will be described in detail later and will not be described here. When the first switching member 119 is held at the solid line position in FIG. 1, the sheet S on which an image is formed on a first side (a front surface) through the image forming path 108 is guided to the first reversing path 128 and is further guided to the second reversing path 209. When the trailing end of the sheet S passes through the branch point 129, the direction of rotation of the reversing roller pair 121, the registration roller pair 210, and the conveying roller pair 212 is reversed, so that the sheet S is guided to the reconveyinq path 126. The sheet S, which has reached the registration roller pair 110, with the first side and the opposite second side (a back surface) reversed, passes through the image forming path 108 again, so that an image is formed on the second side. Thereafter, the first switching member 119 and the second switching member 120 are switched in orientation, so that the sheet S is conveyed to the first stacking unit 124 or the second stacking unit 208. The registration roller pair 210 and the conveying roller pair 212 may be configured to be separable so that the sheet S can be reversely conveyed only by the reversing roller pair 121.

Next, the punching processing performed by the punching processing unit 211 will be described. When the first switching member 119 is held at the solid line position in FIG. 1, the sheet P is guided to the second reversing path 209 in the post-processing unit 200 through the first reversing path 128. The punching unit 224 of the punching processing unit 211 punches in the sheet S conveyed to a predetermined position of the second reversing path 209. The sheet S subjected to the punching processing is directly conveyed toward the binding processing unit 202 or conveyed to the reconveying path 126 by a reverse conveying operation (described later).

### Punching Processing Unit

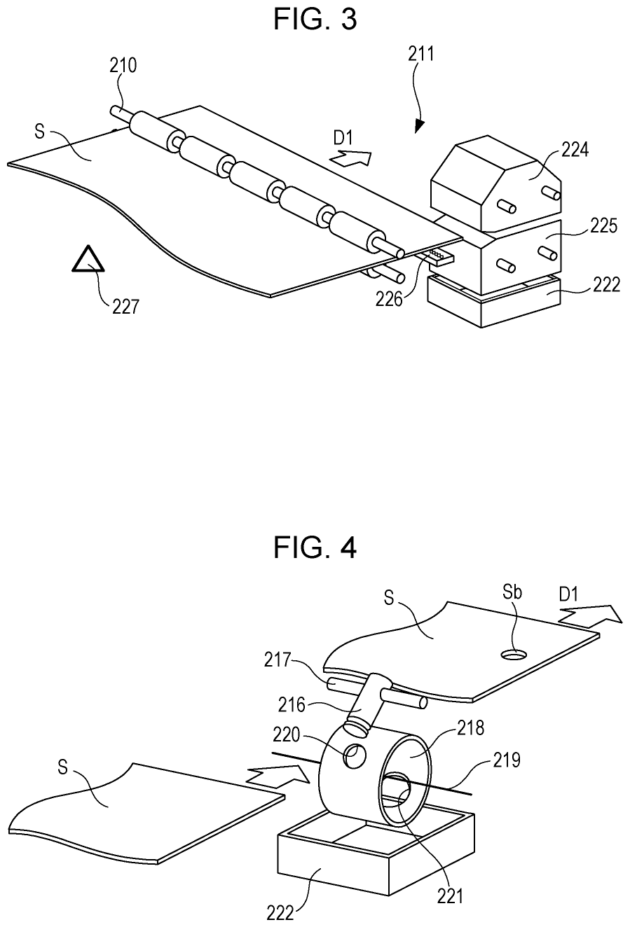

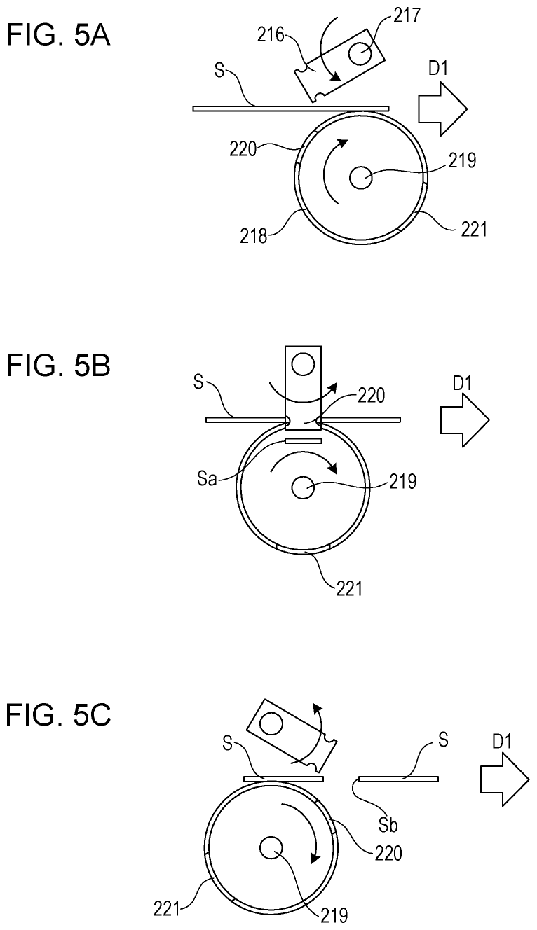

The detailed configuration of the punching processing unit 211 will be described with reference to FIG. 3 to FIGS. 5A to 5C. FIG. 3 is a perspective view of the punching processing unit 211. FIG. 4 is a schematic diagram illustrating the relevant part of the punching processing unit 211. FIGS. 5A to 5C are schematic diagrams illustrating the processing steps of the punching operation of the punching processing unit 211.

As illustrated in FIG. 3, the punching processing unit 211 includes the punching unit 224 and a die unit 225. The punching unit 224 and the die unit 225 are formed as a single unit and can be moved together in the widthwise direction perpendicular to the sheet conveying direction by an actuator (not illustrated). The registration roller pair 210 and a sheet-end detection sensor 226 are disposed in the vicinity of the punching unit 224.

In the vicinity of the registration roller pair 210, the second reversing path 209 is provided with a loop space 228 that allows for bending (looping) of the sheet S (see FIG. 1). After the entry of the sheet S to the second reversing path 209 is detected by the conveyance sensor 227, the registration roller pair 210 is held at rest for a fixed time. This allows the end of the sheet S to abut the nip of the registration roller pair 210 to correct the skew and to form the loop of the sheet S in the loop space 228.

Thereafter, when the registration roller pair 210 starts to rotate, the sheet S is sent in a first conveying direction D1 toward the punching unit 224. When the end of the sheet S is detected by the sheet-end detection sensor 226 disposed downstream from the registration roller pair 210 in the first conveying direction D1, the punching unit 224 and the die unit 225 move in the widthwise direction in response to the detection signal. The punching unit 224 and the die unit 225 operate as the sheet S is conveyed, so that a hole is punched at a predetermined position from the end of the sheet S.

As illustrated in FIG. 4, the punching unit 224 includes a punch 216 which is a punching member, and the die unit 225 includes a die 218 having a punch hole 220 in which the punch 216 is fitted. The punch 216 is rotatable about a punch rotation shaft 217, and the die 218 about a die rotation axis 219 individually in the first conveying direction D1. The die 218 has a punched-scrap removing hole 221. A punched-scrap box 222 is disposed below the die 218. The punched-scrap box 222 is drawn out of the casing of the post-processing unit 200 as the punched-scrap collecting unit 215 (see FIG. 2) is drawn.

A punching operation performed by the punching unit 224 will be described with reference to FIGS. 5A to 5C. FIGS. 5A to 5C illustrate cross-sectional configuration of the punching unit 224 viewed from the widthwise direction. During the punching operation, the sheet S is conveyed to the right in the first conveying direction D1 in the drawings. The punch 216 rotates about the punch rotation shaft 217 counterclockwise in the drawings. In contrast, the die 218 rotates about the die rotation axis 219 clockwise in the drawings. FIG. 5A illustrates a state in which the punch 216 has not yet come into contact with the sheet S.

FIG. 5B illustrates a state in which the sheet S is slightly conveyed from the position in FIG. 5A and is subjected to punching. In other words, the end of the punch 216 shears the sheet S while entering the punch hole 220 of the die 218 to punch a hole in the sheet S. A punched scrap Sa falls into the interior of the die 218 and further falls downward through the punched-scrap removing hole 221 while the die 218 repeatedly rotates into the punched-scrap box 222. FIG. 5C illustrates a state in which the sheet S is slightly conveyed from the position in FIG. 5B. The punch 216 and the die 218 continue to rotate, and the sheet S having the hole Sb is conveyed downstream.

The punch 216 and the die 218 are synchronously rotated by a driving unit (not illustrated) so that the end of the punch 216 is fitted in the punch hole 220 every time. The punch 216 and the die 218 rotate at the same circumferential speed as the conveying speed of the sheet S. By rotating and stopping the punch 216 and the die 218 in accordance with a timing preset according to the conveying speed of the sheet S, a plurality of holes Sb can be punched at any positions of the sheet S.

### Punching Processing in Two-Sided Printing Mode

The image forming apparatus 1 of the present embodiment can execute the punching processing between first-side printing processing and second-side printing processing of two-sided printing and can discharge the sheet S subjected to the punching processing to the first stacking unit 124.

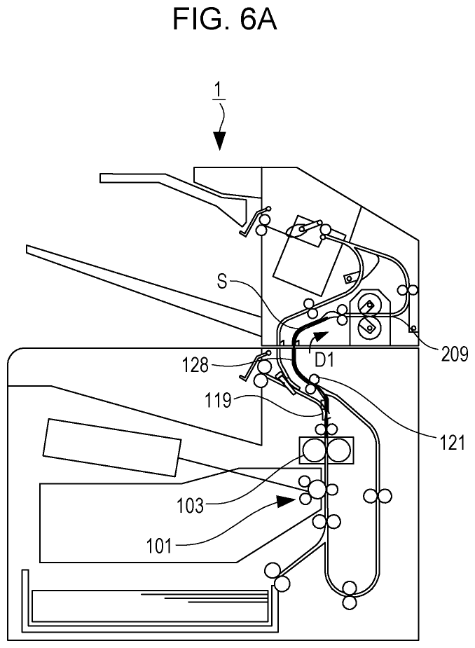

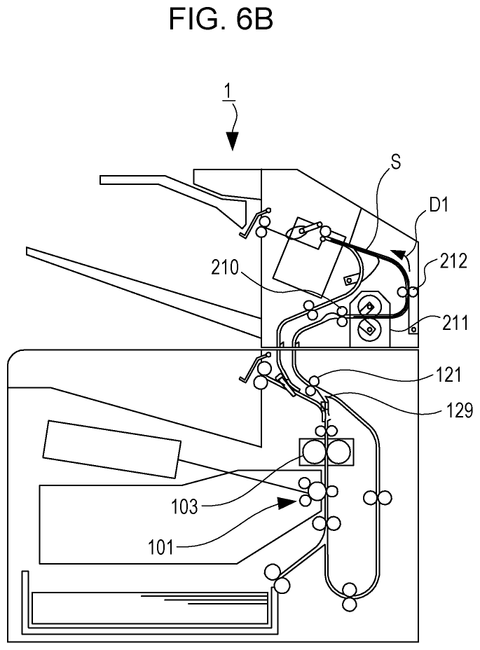

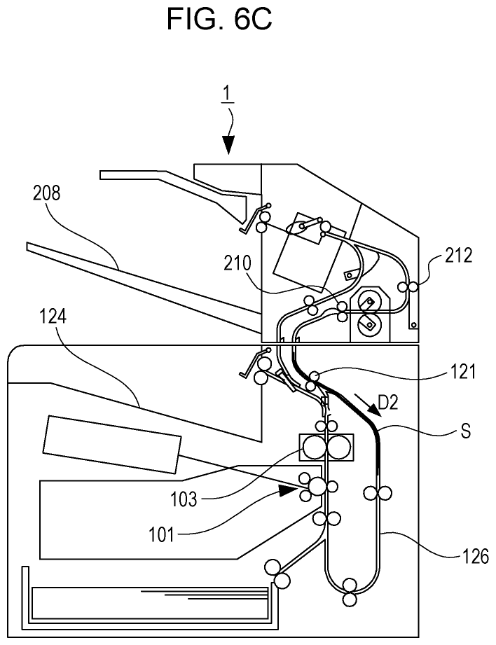

In two-sided printing, as illustrated in FIG. 6A, the first switching member 119 guides the sheet S to the first reversing path 128 and the sheet S is guided to the second reversing path 209 through the first reversing path 128, as described above. Since the punching processing unit 211 is disposed in the second reversing path 209, the sheet S can be subjected to punching processing by conveying the sheet S to a predetermined position in the second reversing path 209. In other words, for two-sided printing without performing punching processing, the conveying direction of the sheet S is reversed soon after the trailing end of the sheet S in the first conveying direction D1 passes through the branch point 129. If punch processing is to be performed, the sheet S is conveyed in the first conveying direction D1 also after the trailing end of the sheet passes through the branch point 129, and the sheet S is subjected to punching processing in the second reversing path 209.

Specifically, after the leading end of the sheet S in the first conveying direction D1 abuts the registration roller pair 210 at rest to correct the skew, the sheet S is further conveyed in the first conveying direction D1 (FIG. 6B). At that time, the sheet S being conveyed is sequentially subjected to punching operation by the punching unit 224 so that a specified number of holes are formed. After completion of all the punching operation, the conveying roller pair 212, the registration roller pair 210, and the reversing roller pair 121 are reversed to convey the sheet S to the reconveying path 126 in a second conveying path D2 (FIG. 6C).

Thereafter, the sheet S passes through the image forming unit 101 and the fixing unit 103, so that an image is formed on the second side. The sheet S is guided by the first switching member 119 and the second switching member 120 and is conveyed along the discharge path 122, so that the sheet S is discharged by the first discharge roller pair 123 onto the first stacking unit 124.

### Control Method

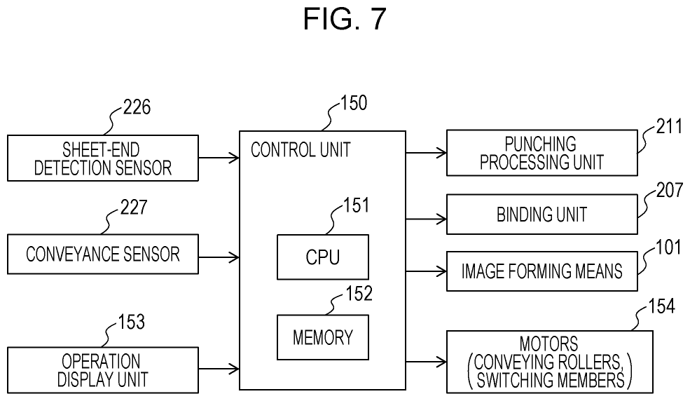

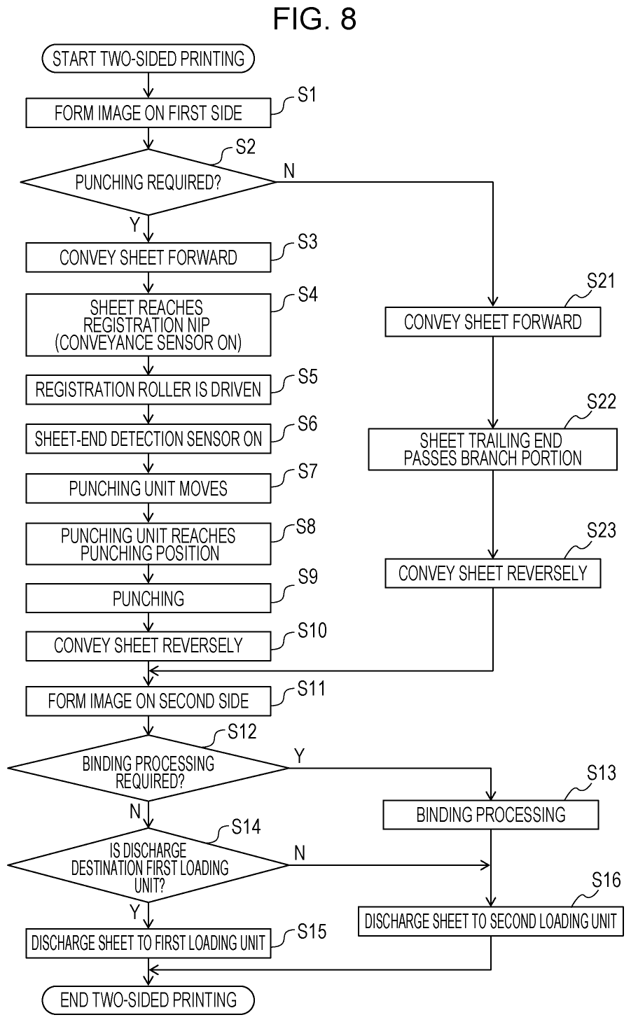

A method for controlling the image forming apparatus that implements the above sheet processing method will be described with reference to FIGS. 7 and 8. FIG. 7 is a block diagram illustrating the control configuration of the image forming apparatus 1 according to the present embodiment. FIG. 8 is a flowchart illustrating the control process of the two-sided printing operation.

As illustrated in FIG. 7, the image forming apparatus 1 according to the present embodiment includes a control unit 150 including a central processing unit (CPU) 151 and a memory 152. The CPU 151 serving as a control unit controls the apparatus main body 100 and the post-processing unit 200 as a whole by reading and executing programs stored in the memory 152. Signals from the sheet-end detection sensor 226, the conveyance sensor 227, and an operation display unit 153 are input to the control unit 150. The operation display unit 153 is a user interface including a liquid-crystal panel and various buttons and allows setting operations on whether to execute two-sided printing, whether to execute punching processing and binding process, and other information. The CPU 151 controls the operations of the punching processing unit 211, the binding processing unit 202, and the image forming unit 101 with reference to setting information input via the operation display unit 153 or setting information contained in a print job received from an external PC. The CPU 151 also controls the conveying rollers for conveying the sheet S and the switching members for switching the conveying paths of the sheet S with a motor 154 serving as an actuator.

A method for controlling the two-sided printing operation will be described with reference to the flowchart in FIG. 8. The following processing steps are executed by the CPU 151. When a print job in which settings for two-sided printing are enabled is input, a first image forming step of forming an image on a first side of the sheet S is executed (S1). If punching processing is not required (S2: N), the sheet S is conveyed through the first reversing path 128 and the second reversing path 209 in the first conveying direction D1 (S21). Thereafter, after the trailing end of the sheet S passes through the branch point 129 (S22), the sheet S is reversely conveyed in the second conveying direction D2 (S23).

If punching processing is required (S2: Y), punching processing (S9) is executed as a sheet processing step before image formation on the second side is executed. First, the sheet S is conveyed in the first conveying direction D1 until the leading end abuts the registration roller pair 210 (S3; FIG. 5A), where the skew is corrected by the registration roller pair 210 (S4). When driving of the registration roller pair 210 is started (S5), an end position of the sheet S in the width direction is detected by the sheet-end detection sensor 225 (S6). Then, the punching unit 224 moves (S7) to reach a punch target position based on the detection result of the sheet-end detection sensor 225 (S8). The punching unit 224 executes a punching operation as the sheet S moves in the first conveying direction D1 to punch a hole at a position specified by the print job (S9; FIG. 5B). Upon completion of the punching to the specified position, the sheet S is reversely conveyed in the second conveying direction D2 (S10; FIG. 5C).

When the sheet S is reversely conveyed again to the image forming path 108 through the reconveying path 126, a second image forming step of forming an image on the second side of the sheet S is executed (S11). If execution of binding processing is required in the print job (S12: Y), the sheet S is conveyed to the binding processing unit 202, where the sheet S is subjected to binding processing into a batch of sheets (S13), and the batch of sheets is discharged onto the second stacking unit 208 by the second discharge roller pair 205 (S16). If execution of binding processing is not required, and the first stacking unit 124 is specified as a discharge destination (S12: N, S14: Y), the sheet S is discharged onto the first stacking unit 124 by the first discharge roller pair 123 (S15). If binding processing is not required, and the first stacking unit 124 is not specified as a discharge destination (S12: N, S14: N), the sheet S is conveyed to the post-processing unit 200 and is discharged onto the second stacking unit 208 by the second discharge roller pair 205 (S16).

For the orientation of image formation, the binding unit 207 in the present embodiment is disposed so as to bind the trailing ends of the sheets S in the conveying direction. For that reason, processing for rotating the image to be formed by the image forming unit 101 180° to align the orientation of the image with the binding position.

Thus, in the present embodiment, the sheet processing step (S9) of processing the sheet S is executed in the reverse conveying steps (S3 to S10) of reversely conveying the sheet S between the image forming steps (S1 and S11) of forming images on the first side and the second side of the sheet S. In other words, the sheet processing is executed by using part of the time required to reversely convey the sheet S. This reduces the time required to complete the image forming step and the sheet processing step as compared with a case in which the sheet processing step is executed after completion of image formation on the both sides of the sheet S, thus increasing the production efficiency of the image forming apparatus 1.

This image forming method is implemented by disposing the punching processing unit 211 in the second reversing path 209 in the post-processing unit 200. In other words, a productive image forming method is implemented by using a configuration in which a sheet S in which an image is formed on the first side is conveyed by the punching processing unit 211 (the first processing unit), with the first side and the second side reversed.

In particular, the present embodiment is configured, in a configuration in which the image forming unit 101 is housed in the apparatus main body 100 (the first casing), and the punching processing unit 211 is housed in the post-processing unit 200 (the second casing), to discharge the sheet S subjected to punching processing to the first stacking unit 124, which is a stacking unit in the first casing. A sheet S for which only punching processing is required and binding processing is not required is discharged to the first stacking unit 124 after two-sided printing. In other words, if there is no need to convey the sheet S conveyed to the image forming unit 101 by the reverse conveying unit to the second casing again, the sheet S can be directly discharged to the stacking unit in the first casing, thereby further enhancing the production efficiency of the image forming apparatus 1.

The present embodiment is configured such that the post-processing unit 200 (the second casing) includes the second stacking unit 208 so that the discharge destination of the sheet S can be chosen from the first stacking unit 124 and the second stacking unit 208 as necessary. Thus, even when a large amount of sheets S are subjected to image formation and sheet processing, the sheets S can be stacked on both of the first stacking unit 124 and the second stacking unit 208. In contrast, in the case of the related art where the sheet S is processed by the post-processing unit, the sheet S is discharged to a stacking unit in the post-processing unit, so that it is difficult to cope with a large amount of sheets S as compared with the present embodiment.

In the present embodiment, the second reversing path 209 corresponding to the third conveying path and the second binding path 201 corresponding to the fifth conveying path join together in the post-processing unit 200. This allows the destination of the sheets S subjected to the punching processing to be chosen from the reconveying path 126 and the binding processing unit 202, thereby increasing the flexibility of processing that the image forming apparatus 1 can execute. In other words, the CPU 151 of the present embodiment can execute a mode of conveying the sheet S subjected to the punching processing directly to the binding processing unit 202 and a mode of discharging the sheet S subjected to the punching processing to the first stacking unit 124 through the reconveying path 126.

### Modifications

The punching processing unit 211 (the first processing unit) and the binding processing unit 202 (the second processing unit) are examples of processing means configured to process the sheet S, which may be means for other processes. For example, instead of the punching processing unit 211, a unit for processing one sheet, such as a stamp unit that stamps the sheet S, may be used as the first processing unit. Instead of the binding processing unit 202, a staple-less stapler for staple-less fastening or a folding unit for saddle stitching may be used as the second processing unit.

In the configuration of the first embodiment, the punching processing unit 211 (the first processing unit) may be disposed as upstream in the second reversing path 209 (a position closer to the first reversing path 128) as possible. This suppresses an increase in sheet conveying distance in punching processing as compared with a case in which no punching processing is performed, thus enhancing the production efficiency of the image forming apparatus 1.

In the present embodiment, the sheet S subjected to the punching processing by the punching processing unit 211 is discharged to the first stacking unit 124, with the sheet S subjected to two-sided printing. Alternatively, for example, a mode of conveying the sheet S to the second reversing path 209 without executing image formation on the first side, performing punching processing, and then forming an image only on the second side may be implemented. This allows choosing an operation of discharging the sheet S in which an image is formed on one side and which is subjected to punching processing to the first stacking unit 124.

The punching processing unit 211 and the image forming unit 101 may be housed in one casing. In this case, it is preferable that the first reversing path 128 and the second reversing path 209 respectively corresponding to the second conveying path and the third conveying path be integrated to one sheet conveying path and that the first binding path 127 and the second binding path 201 respectively corresponding to the fourth conveying path and the fifth conveying path be integrated to one sheet conveying path. In this case, the punching processing unit 211 is preferably disposed at a position close to the uppermost stream reverse conveying unit (the reversing roller pair 121 in the present embodiment).

### Second Embodiment

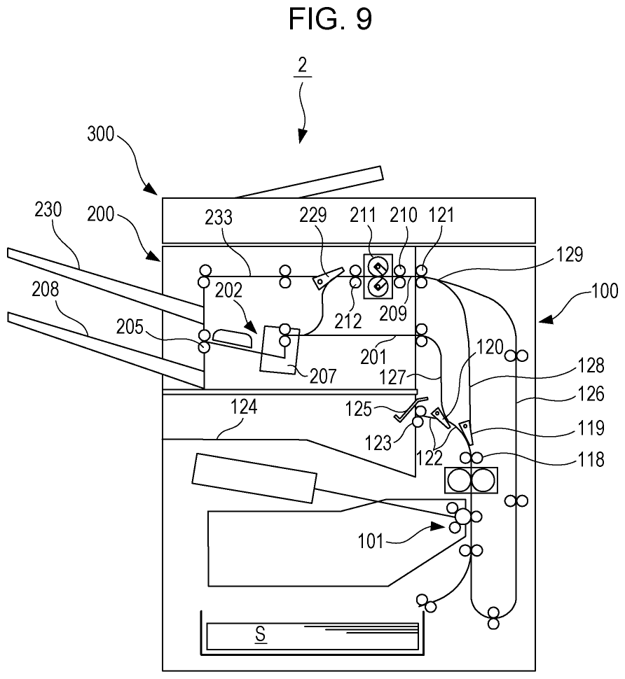

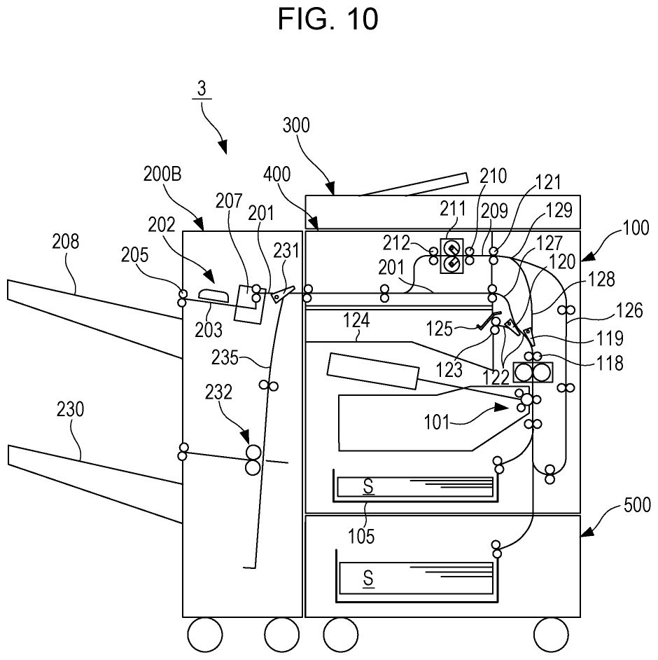

Next, an image forming apparatus 2 according to a second embodiment will be described with reference to FIG. 9. The image forming apparatus 2 according to the present embodiment differs from the image forming apparatus 1 of the first embodiment in including a so-called intra-body discharge space, in which the post-processing unit 200 is mounted. The other components common to the components of the first embodiment are given the same reference signs as those of the first embodiment, and descriptions thereof will be omitted.

The image forming apparatus 2 includes an apparatus main body 100 including an image forming unit 101 and an image reading unit 300 which is mounted on the top of the apparatus main body 100 and which serves as an image scanner configured to read image information from an original. The image reading unit 300 includes an original feeding unit that automatically feeds originals, a scanning unit that optically scans the surface of the original, and a photoelectric conversion element that converts the optical image of the original guided from the scanning unit to electronic data. The image reading unit 300 is at a position overlapping with the apparatus main body 100 viewed from above. The intra-body discharge space to which the sheets S can be discharged is provided between the image reading unit 300 and the apparatus main body 100 in the vertical direction. The post-processing unit 200 is detachably mounted in the intra-body discharge space of the apparatus main body 100.

Also in the present embodiment, the apparatus main body 100 includes the discharge path 122 (the first conveying path) and the first reversing path 128 (the second conveying path). The first reversing path 128 is connected to the second reversing path 209 (the third conveying path) disposed in the post-processing unit 200. The apparatus main body 100 further includes the first binding path 127 (the fourth conveying path) branching off the discharge path 122. The first binding path 127 is connected to the second binding path 201 (the fifth conveying path) disposed in the post-processing unit 200. The first switching member 119 and the second switching member 120 are respectively disposed at the branch point between the discharge path 122 and the first reversing path 128 and the branch point between the discharge path 122 and the first binding path 127.

The post-processing unit 200 includes the punching processing unit 211 disposed in the second reversing path 209 and the binding processing unit 202 disposed downstream. in the second binding path. The second reversing path 209 and the second binding path 201 join together in the post-processing unit 200. The post-processing unit 200 includes a third stacking unit 230 (an upper stacking unit) above the second stacking unit 208 (a lower stacking unit) to which a batch of sheets S bound by the binding processing unit 202. A switching member 229 that guides the sheet S that has passed through the punching processing unit 211 to either a conveying path to the binding processing unit 202 or a conveying path 233 to the upper stacking unit 230 is disposed in the post-processing unit 200.

In the present embodiment, the operation for punching in the sheet S in two-sided printing is the same as the operation described in the first embodiment. In other words, also the configuration of the present embodiment allows punching processing with the punching processing unit 211 on the sheet S that is reversely conveyed by the reversing roller pair 121, the registration roller pair 210, and the conveying roller pair 212 serving as a reverse conveying unit. In two-sided printing, this configuration allows punching processing after image formation on the first side is performed and discharging the sheet S in which an image is formed on the second side to the first stacking unit 124. Thus, the configuration of the present embodiment has the same advantageous effects as those of the first embodiment.

### Third Embodiment

Next, an image forming apparatus 3 according to a third embodiment will be described with reference to FIG. 10. The image forming apparatus 3 of the present embodiment differs from the image forming apparatus 1 of the first embodiment in that it includes a relay conveying unit 400 disposed in an intra-body discharge space and that a post-processing unit 200B processes the sheet S received from the relay conveying unit 400. The other components common to the components of the first embodiment are given the same reference signs as those of the first embodiment, and descriptions thereof will be omitted.

Also in the present embodiment, the apparatus main body 100 includes the discharge path 122 (the first conveying path) and the first reversing path 128 (the second conveying path). The first reversing path 128 is connected to the second reversing path 209 (the third conveying path) disposed in the relay conveying unit 400. The apparatus main body 100 further includes the first binding path 127 (the fourth conveying path) branching off the discharge path 122. The first binding path 127 is connected to the second binding path 201 (the fifth conveying path) disposed in the relay conveying unit 400. The first switching member 119 and the second switching member 120 are respectively disposed at the branch point between the discharge path 122 and the first reversing path 128 and the branch point between the discharge path 122 and the first binding path 127.

The relay conveying unit 400 (a second casing) includes the punching processing unit 211 disposed in the second reversing path 209. The second reversing path 209 and the second binding path 201 join together in the relay conveying unit 400. The post-processing unit 200B (a third casing) connected to the second casing includes the binding processing unit 202 that performs binding processing on a plurality of sheets S and a folding unit 232 that folds the sheet S. The binding processing unit 202 and the folding unit 232 are examples of a processing unit (a second processing unit) that processes the sheet S. Instead of the binding processing unit 202 and the folding unit 232, a saddle stitching unit, a cutting unit, or another processing unit may be disposed.

The second binding path 201 extends into the post-processing unit 200B. The post-processing unit 200B includes a folding path 235 that branches off the second binding path 201 toward the folding unit 232. At the branch point between the second binding path 201 and the folding path 235, a switching member 231 configured to switch between an orientation for guiding the sheet S to the binding processing unit 202 and an orientation for guiding the sheet S to the folding unit 232 is disposed.

The sheet S subjected to binding processing by the binding processing unit 202 is discharged and stacked onto the second stacking unit 208 by the second discharge roller pair 205 (the second discharge unit). The sheet S folded by the folding unit 232 is discharged and stacked onto the third stacking unit 230 (the lower stacking unit) disposed below the second stacking unit 208.

A feeding unit 500 is joined to the bottom of the apparatus main body 100, so that sheets S of different sizes can be fed or a large amount of sheets S can be continuously fed by the combination use of the sheet cassette 105 mounted in the apparatus main body 100.

In the present embodiment, the operation for punching the sheets S in two-sided printing is the same as the operation described in the first embodiment except that the sheets S are conveyed to the post-processing unit 200B for binding processing via the relay conveying unit 400. In other words, also in the present embodiment, punching processing can be performed, by the punching processing unit 211, on the sheet S reversely conveyed by the reversing roller pair 121, the registration roller pair 210, and the conveying roller pair 212 serving as a reverse conveying unit. In two-sided printing, the punching processing can be performed after image formation on the first side is performed, and the sheet S on which an image is formed on the second side can be discharged to the first stacking unit 124. Accordingly, the scalable configuration of the present embodiment in which a feeding unit, a post-processing unit, and another unit can be joined to the apparatus main body of the image forming apparatus has the same advantageous effects as those of the first embodiment.

### Fourth Embodiment

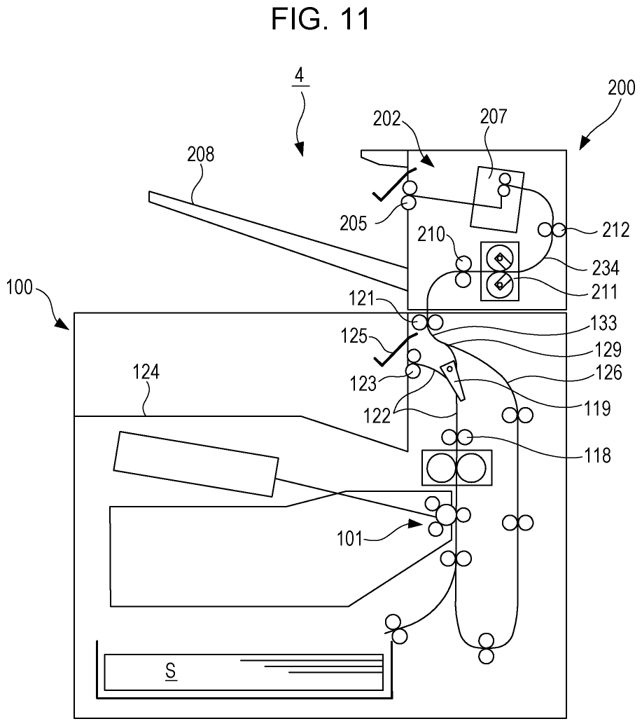

Next, an image forming apparatus 4 according to a fourth embodiment will be described with reference to FIG. 11. The image forming apparatus 4 of the present embodiment differs from the image forming apparatus 1 of the first embodiment in the arrangement of the sheet conveying path, the punching processing unit 211, and the binding processing unit 202 in the post-processing unit 200. The other components common to the components of the first embodiment are given the same reference signs as those of the first embodiment, and descriptions thereof will be omitted.

In the present embodiment, the apparatus main body 100 includes the first discharge path 122 (a first conveying path) and a second discharge path 133 (a second conveying path). The second discharge path 133 is connected to a third discharge path 234 (a third. conveying path) disposed in the post-processing unit 200. The punching processing unit 211 is disposed in the third discharge path 234. The binding processing unit 202 is disposed downstream in the third discharge path 234. The first switching member 119 is disposed at the branch point between the first discharge path 122 and the second discharge path 133.

In this configuration, a conveying path constituted by the second discharge path 133 and the third discharge path 234 is used both as a conveying path for reversely conveying the sheet S in two-sided printing and a conveying path for conveying the sheet S toward the binding processing unit 202. In other words, in punching the sheet S in two-sided printing, the sheet S in which an image is formed on the first side is conveyed to the third discharge path 234, where the sheet S is punched by the punching processing unit 211. Thereafter, the sheet S is sent to the reconveying path 126 by the reverse rotation of the reversing roller pair 121, the registration roller pair 210, and the conveying roller pair 212, and an image is formed on the second side of the sheet S by the image forming unit 101. The sheet S is guided to the second discharge path 133 or the first discharge path 122 by the first switching member 119, is bound by the binding process as necessary, and is discharged and stacked onto the first stacking unit 124 or the second stacking unit 208.

In the present embodiment, the operation for punching in the sheet S in two-sided printing is the same as the operation described in the first embodiment except that the sheet S is conveyed through the same path in the punching processing and the binding processing. Thus, also in the present embodiment, punching processing can be performed by the punching processing unit 211 on the sheet S reversely conveyed by the reverse conveying unit. In two-sided printing, the punching processing can be performed after image formation on the first side is performed, and the sheet S on which an image is formed on the second side can be discharged to the first stacking unit 124. Accordingly, the configuration of the present embodiment has the same advantageous effects as those of the first embodiment.

In the present embodiment, the punching processing unit 211 and the binding processing unit 202 are arranged in series with respect to the third discharge path 234. This provides the function of discharging the punched sheet S to the first stacking unit 124 by using a simple and compact configuration.

### Other Embodiments

The image forming unit is an example of image forming unit and may be an image forming unit of another method, such as an inkjet method.

Embodiments of the present disclosure can also be realized by a computer of a system or apparatus that reads out and executes computer executable instructions (e.g., one or more programs) recorded on a storage medium to perform the functions of one or more of the above-described embodiments and/or that includes one or more circuits (e.g., application specific integrated circuit (ASIC)) for performing the functions of one or more of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image forming apparatus comprising:
an image forming unit configured to form an image on a sheet; and
a conveying unit connected to the image forming unit and configured to convey the sheet discharged from the image forming unit,
wherein the conveying unit is configured to convey the sheet in which an image is formed on a first side by the image forming unit toward the image forming unit, with the first side and a second side opposite to the first side reversed, and
wherein the conveying unit includes a first processing unit configured to perform processing on the sheet having the image formed on the first side by the image forming unit and conveyed toward the image forming unit by the conveying unit.

2. The image forming apparatus according to claim 1, wherein the image forming unit includes:
a first stacking unit on which the sheet processed by the first processing unit is to be stacked, and
a first discharge unit configured to discharge the sheet processed by the first processing unit to the first stacking unit.

3. The image forming apparatus according to claim 2, wherein the conveying unit includes:
a second processing unit configured to perform processing on the sheet processed by the first processing unit,
a second stacking unit on which the sheet is to be stacked, and
a second discharge unit configured to discharge the sheet processed by the second processing unit to the second stacking unit.

4. The image forming apparatus according to claim 3, further comprising a switching member configured to switch between a first orientation for guiding the sheet sent from the image forming unit toward the first discharge unit and a second orientation for guiding the sheet sent from the image forming unit toward the second processing unit.

5. The image forming apparatus according to claim 3,
wherein the image forming unit includes a first conveying path through which the sheet on which the image is formed by the image forming unit is conveyed toward the first discharge unit, and a second conveying path branching off the first conveying path,
wherein the conveying unit includes a third conveying path connected to the second conveying path, and
wherein the first processing unit is disposed in the third conveying path.

6. The image forming apparatus according to claim 5,
wherein the image forming unit includes a fourth conveying path branching off the first conveying path and configured to convey the sheet toward the conveying unit,
wherein the conveying unit includes a fifth conveying path connected to the fourth conveying path and configured to convey the sheet toward the second processing unit, and
wherein the third conveying path and the fifth conveying path join together in the conveying unit.

7. The image forming apparatus according to claim 5,
wherein the first processing unit is configured to perform processing on one sheet, and
wherein the second processing unit is configured to perform processing on a plurality of sheets.

8. The image forming apparatus according to claim 7, further comprising image reading unit disposed above the image forming unit and configured to read image information from an original,
wherein the conveying unit is disposed between the image reading unit and the image forming unit in a vertical direction.

9. The image forming apparatus according to claim 1, wherein the first processing unit is configured to form a hole in the sheet by performing the processing on the sheet.

10. The image forming apparatus according to claim 3, wherein the second processing unit is configured to bind the sheet by performing the processing on the sheet.

11. A method for an image forming apparatus having an image forming unit, the method comprising:
forming an image on a first side of a sheet by using the image forming unit;
reversing a conveying direction of the sheet having the image formed on the first side toward the image forming unit; and
forming an image on a second side opposite to the first side by using the image forming unit,
wherein reversing includes forming a hole in the sheet.
